(19) United States
(12) Patent Application Publication
(10) Pub. No.: US 2006/0010257 A1
(43) Pub. Date: Jan. 12, 2006

(54) Method and apparatus for acquiring device information

(76) Inventor: Mike Hardcastle, Colorado Springs, CO (US)

Correspondence Address: HEWLET-PACKARD COMPANY;Intellectual Property Administration, P.O. Box 272400, Fort Collins, CO, 80527-2400, US

(21) Appl. No.: 10/887,952

(22) Filed: Jul. 8, 2004

(51) Int. Cl. G06F 3/00

(52) U.S. Cl. 710/1

(57) ABSTRACT

Disclosed herein is a method and corresponding apparatus for conveying office peripheral information. An acquisition module included in a device establishes a connection to an aggregation module. Device information is communicated to the aggregation module using the established connection.

### BACKGROUND OF THE INVENTION

In today's networked environments, many varied types of office peripherals interact with each other and with other devices attached to a network. A network structure can be found in a wide variety of environments. For example, an office environment is just one of many types of venues where a networking structure can be found. Hospitals, motion picture studios and factories are also venues where networking structures are utilized. Even the modern battlefield uses networking structures to facilitate the acquisition of intelligence and direct resources for strategic and tactical purposes. These are just some examples of a myriad of networking environments.

In each of these networking environments, different types of office peripherals need to communicate information amongst each other or to other devices attached to a network. An office peripheral includes, but is not limited to a printer, a facsimile machine, a scanner, a plotter, a file server, a networked disk and a network gateway. A printer is a good example of an office peripheral that may need to communicate information to another device attached to a network. For example, a printer may need to communicate status information to a computer workstation. For example, when the printer runs out of paper this type of status information is often communicated to the workstation and then conveyed to a human user. Once the information is received in the workstation, the human user is presented with a message indicating that the printer has run out of paper.

Up until now, communication of information from an office peripheral to either of another office peripheral or another device attached to a network has been accomplished in various manners, none of which provides for an effective means of ensuring the delivery of the information. One typical means that has been employed for communicating information from an office peripheral to another office peripheral or to another device attached to a network is known as a network “trap”. A network trap is typically defined as a broadcast message conveyed to a network. For example, the simple network management protocol (SNMP) provides for such traps. Under the SNMP definition, a trap is typically broadcast within a subnet. A device (i.e. another office peripheral or any other device attached to the network) that needs the information may not necessarily be connected to the same subnet. Ergo, such a device will simply not receive the information it needs.

One means that has been used to collect office peripheral information in a more reliable manner is known as “polling”. A device that needs information from an office peripheral can interrogate the office peripheral in order to obtain the needed information. Polling does provide assurance that the information is actually received. Polling, however, becomes impractical for obtaining such information as the number of office peripherals on a network increases. For example, where a group of workstations in an office environment needs to interrogate the status of a printer, each workstation will need to independently poll the printer. Accordingly, message traffic increases proportionally with the number of devices that need to obtain information from the office peripherals attached to a network.

### SUMMARY OF THE INVENTION

Disclosed herein is a method and corresponding apparatus for conveying office peripheral information. An acquisition module included in an office peripheral establishes a connection to an aggregation module. Office peripheral information is communicated to the aggregation module using the established connection.

### BRIEF DESCRIPTION OF THE DRAWINGS

The present invention will hereinafter be described in conjunction with the appended drawings and figures, wherein like numerals denote like elements, and in which:

FIGS. 1 and 2 collectively comprise a flow diagram that depicts one example embodiment of a method for acquiring device information;

FIG. 3 is a flow diagram that depicts one alternative example embodiment of a method for establishing a connection to an aggregation module;

FIG. 4 is a flow diagram that depicts one illustrative alternative embodiment of a method for establishing a connection according to an established time period;

FIG. 5 is a flow diagram that depicts one example alternative embodiment of a method for establishing a connection according to an established time period;

FIG. 6 is a flow diagram that depicts yet another alternative embodiment of the present method for establishing a connection;

FIG. 7 is a flow diagram that depicts alternative methods for communicating device information;

FIG. 8 is a flow diagram that depicts alternative methods for seeding an acquisition module into a device;

FIG. 9 is a block diagram that depicts one example embodiment of a device capable of communicating device information according to the present method;

FIG. 10 is a block diagram that depicts alternative embodiments of a communications unit;

FIG. 11 is a block diagram that depicts one alternative embodiment of a device capable of communicating device information according to present method;

FIG. 12 is a data flow diagram that depicts the operation of one alternative embodiment of a device capable of communicating device information according to the present method; and

FIG. 13 is a block diagram that depicts one example embodiment of a device seeding apparatus.

### DETAILED DESCRIPTION

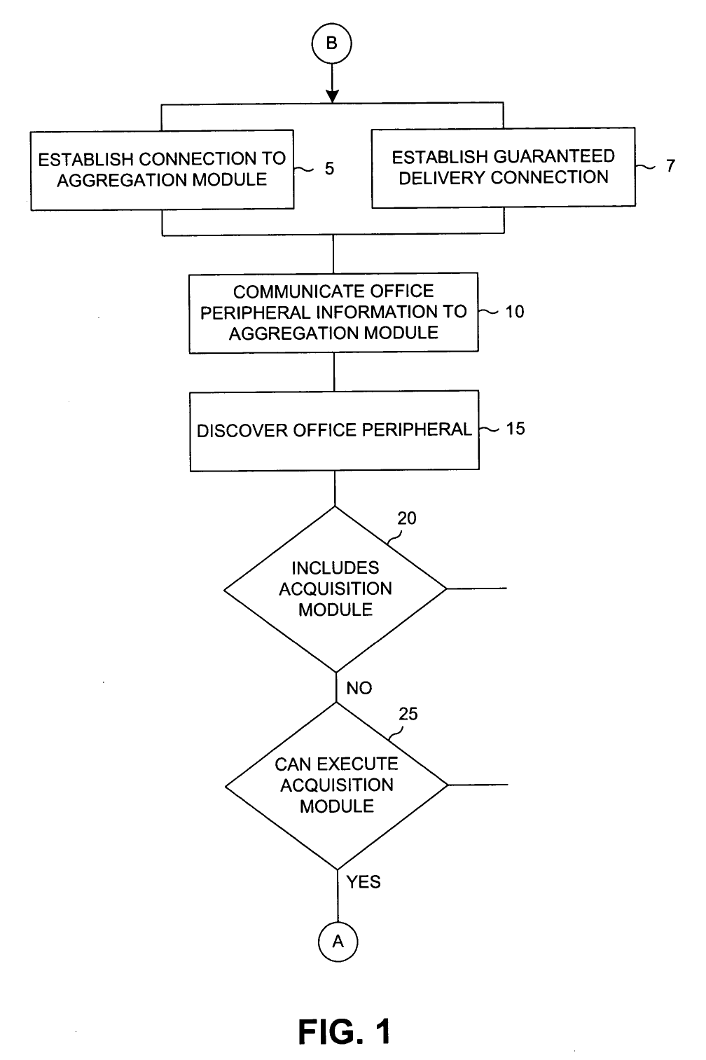

FIGS. 1 and 2 collectively comprise a flow diagram that depicts one example embodiment of a method for acquiring information from an office peripheral. An office peripheral includes, but is not limited to a printer, a scanner, a facsimile machine, a disk farm, a server, a print server, a communications gateway and a plotter. These examples of office peripherals are presented herein to illustrate the present method and are not intended to limit the scope of the claims appended hereto. According to this example method, device information is acquired from an office peripheral by establishing a connection to an aggregation module (step 5) and then communicating information from the office peripheral to the aggregation module using the established connection (step 10). In one example use case, the connection is established from an acquisition module included in an office peripheral. The acquisition module comprises any suitable embodiment capable of acquiring the information that needs to be communicated to a device attached to a network. According to one alternative embodiment of the present method, establishing a connection to an aggregation module comprises the establishment of a connection that provides for guaranteed delivery of the office peripheral's information to the aggregation module (step 7).

In some cases, the present method is applied where an office peripheral already includes an acquisition module as herein described. In one alternative use case, the present method is applied where an office peripheral does not include an acquisition module as herein described. Accordingly, one alternative embodiment of the present method provides for discovering an office peripheral (step 15). One method for discovering an office peripheral is to go cycle through a list of addresses available on a subnet and do an SNMP ‘get’ of a few objects that a printer would respond to. If the SNMP get returns expected values, we know if it a printer and can manage the device. According to another example method, traffic on a network is monitored to discover traffic associated with an office peripheral.

Once an office peripheral is discovered, some means of ascertaining whether the office peripheral includes an acquisition module (step 20) is provided. When the office peripheral does not include an acquisition module, this alternative embodiment of the present method provides for determining if the office peripheral can accept and execute an acquisition module (step 25). When the office peripheral can accept and execute an acquisition module, this alternative embodiment of the present method provides for seeding an acquisition module into the office peripheral (step 30). Once the acquisition module is seeded into the office peripheral, the acquisition module is allowed to execute (step 35). The acquisition module then adheres to the presently disclosed method for establishing a connection to an aggregation module heretofore described.

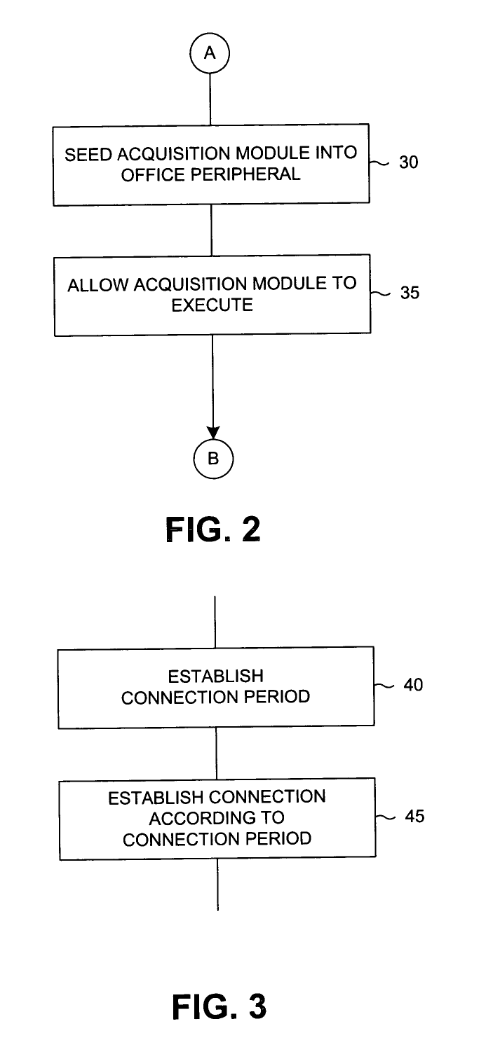

FIG. 3 is a flow diagram that depicts one alternative example embodiment of a method for establishing a connection to an aggregation module. According to this alternative example embodiment of the present method, a connection to an aggregation module is established by first establishing a connection period (step 40). In many cases, the present method is applied in situations where information from an office peripheral must be provided to another device on some regular interval. According to this alternative example method, a connection from the acquisition module included in an office peripheral is established to an aggregation module according to the connection period (step 45).

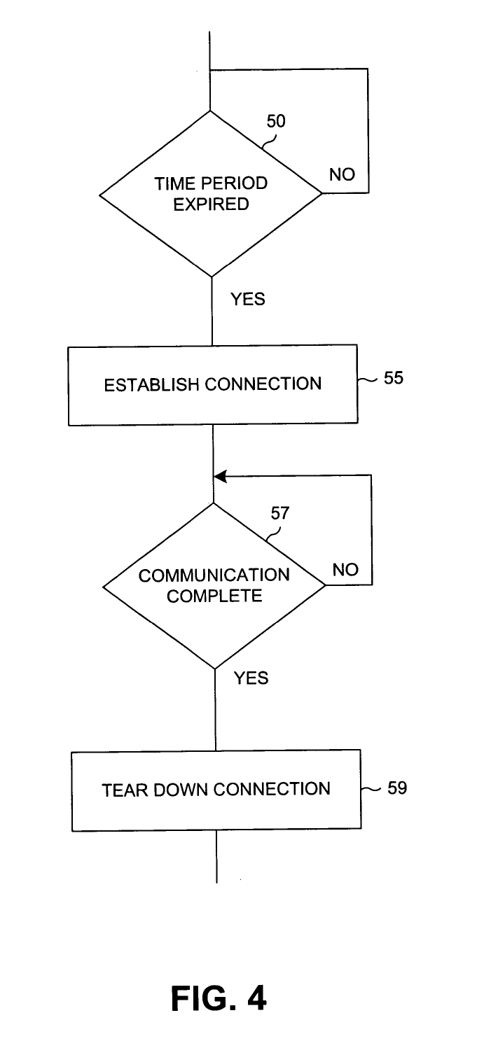

FIG. 4 is a flow diagram that depicts one illustrative alternative embodiment of a method for establishing a connection according to an established time period. According to this illustrative alternative embodiment, a connection is established (step 55) once a time period has expired (step 50). According to this alternative embodiment of the present method, the connection is maintained until communication of information is complete (step 57). Once all information from an office peripheral has been communicated during a particular time period, the connection is torn down (step 59). This illustrative alternative embodiment of the present method may be applied where information is to be communicated from an office peripheral to another device on a periodic basis. According to one alternative embodiment of the present mentod, a timer is used to establish the time period. The timer, according to one example embodiment of the method, is implemented as a hardware register that maintains a system time. According to yet another alternative example embodiment, the timer is implemented as a software register. Accordingly, the software register is updated on a periodic basis, e.g. in response to a periodic interrupt signal received by a processor executing software.

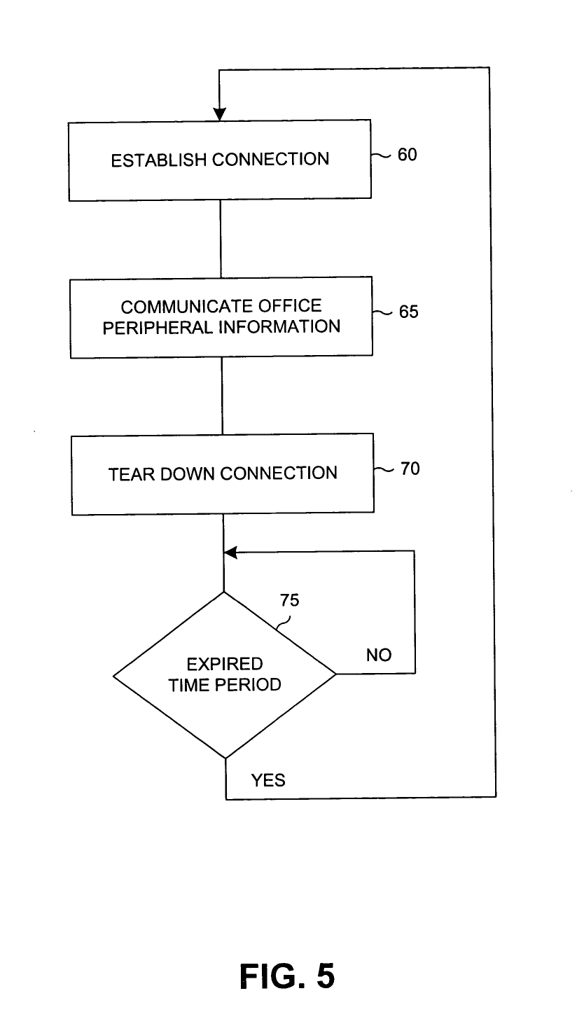

FIG. 5 is a flow diagram that depicts one example alternative embodiment of a method for establishing a connection according to an established time period. Similar to the alternative method described in FIG. 4, this alternative embodiment of the present method provides for establishing a connection (step 60), communicating information from an office peripheral using the established connection (step 65) and tearing down the connection once the information is communicated (step 70). A timer is initiated and this process is repeated once the timer is expired (step 75). It should be noted that, in the context of the present method for acquiring information from an office peripheral, that a communications channel can be established and torn down whenever information needs to be communicated from the source device (i.e. an office peripheral) to a device that needs the information. Accordingly, any suitable method may be applied for triggering the establishment and termination of a communications channel. For example, once information from the office peripheral is communicated using an established communications channel, a semaphore may be used to indicate to a communications system that a communications channel should be torn down.

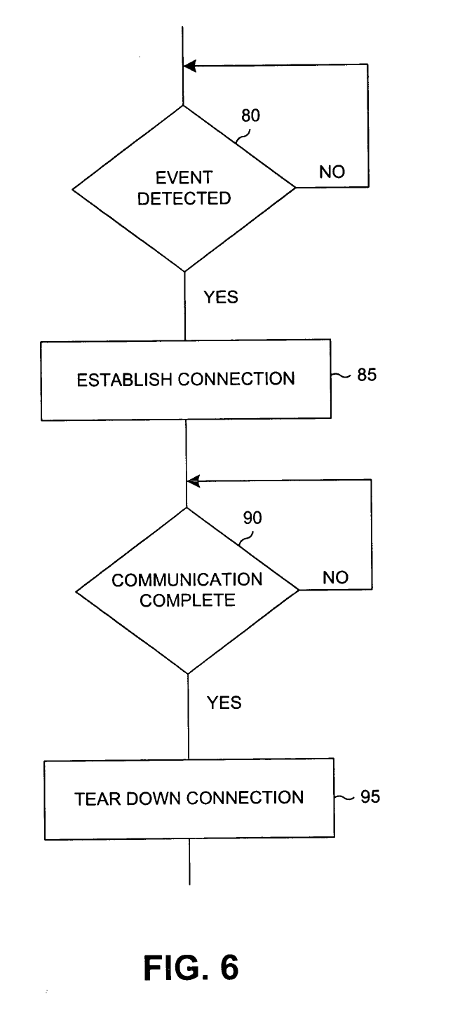

FIG. 6 is a flow diagram that depicts yet another alternative embodiment of the present method for establishing a connection. According to this alternative embodiment, a connection is established (step 85) when an event is detected (step 80). Various types of events may occur within a wide variety of types of office peripherals. For example, in an office peripheral that constitutes a printer, an event may include detection of a low toner level. Another type of event may include detection that a paper supply has been exhausted. These examples of events are presented in order to illustrate, but not limit the scope of the claims appended hereto. According to this alternative embodiment of the present method, once the event is detected (step 80), the connection is established (step 85). According to one alternative embodiment of the present method, the connection is maintained until communication of information from the office peripheral is complete (step 90). Once information from the office peripheral has been communicated, this alternative embodiment provides that the connection established between an office peripheral and an aggregation module is to be torn down (step 95). It should be noted that even in this event driven alternative method, various mechanisms may be used to indicate when communication of information from the office peripheral is complete and that a connection may be torn down. For example, the process that communicates information from the office peripheral may use a semaphore to indicate that the connection is no longer needed.

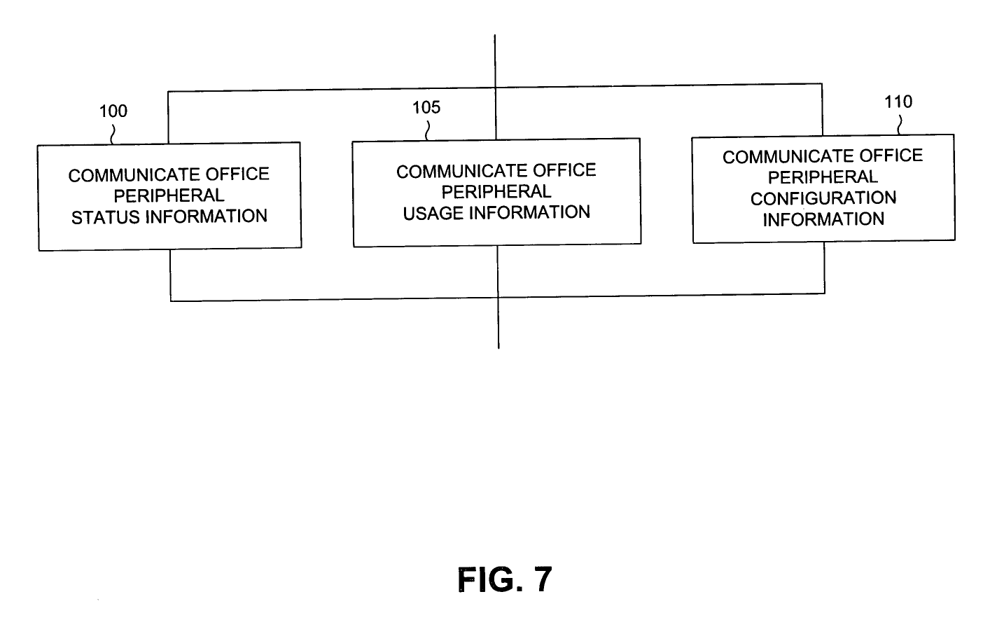

FIG. 7 is a flow diagram that depicts alternative methods for communicating information from an office peripheral. According to this alternative method, information from an office peripheral is communicated by communicating at least one of office peripheral status information (step 100), office peripheral usage information (step 105) and office peripheral configuration information (step 110). Office peripheral status information can vary according to the type of office peripheral that is communicating status information to another device. It is important to note that the claims appended hereto are intended to include all forms of office peripheral status, office peripheral usage and office peripheral configuration information. Several alternative use cases are discussed herein as a means of describing the application of the present method. None of these alternative use cases are intended to limit the scope and application of the claims appended hereto.

A printer is one type of office peripheral that can communicate information to other devices according to the present method. A printer can communicate various forms of status information including, but not limited to “out-of-paper”, “printer-jam”, “out-of-toner”, “out-of-ink”, “printer-open” and “on-line”. These various types of printer status indicators are self-explanatory in meaning and are intended to illustrate the present method. Accordingly, these examples of status information pertaining to a printer are not intended to limit the scope of the claims appended hereto. A printer can communicate various forms of office peripheral usage information including, but not limited to “pages-printed” and “toner-used”. A printer can also communicate other forms of office peripheral usage information (e.g. “amount-of-memory-in-use”). All of these forms of office peripheral usage information that pertain to a printer are not intended to limit scope of the claims appended hereto. A printer can also communicate various forms of configuration information. For example, a printer can communicate configuration information including, but not limited to “graphics-language”, “fonts-installed-list”, “memory-capacity” and “network-identification”. As with office peripheral status information, these indicators of office peripheral usage and office peripheral configuration are self-explanatory in meaning and are intended to illustrate the present method. Accordingly, these examples of office peripheral usage and office peripheral configuration information pertaining to a printer are not intended to limit the scope of the claims appended hereto. The present method may be applied for conveying information from other forms of devices including, but not limited to scanners, fax machines and disk-arrays. These are just a few examples of office peripherals that can utilize the present method in a networked environment.

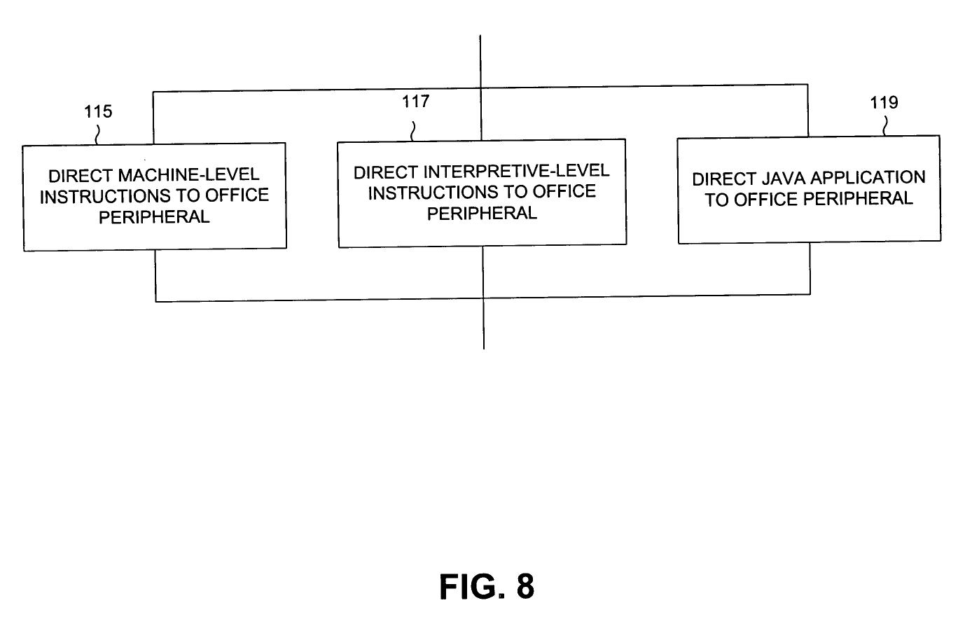

FIG. 8 is a flow diagram that depicts alternative methods for seeding an acquisition module into an office peripheral. Once an office peripheral is discovered and it is determined that the office peripheral does not include an acquisition module and yet is capable of accepting and executing an acquisition module, the present method provides for various alternative methods for seeding an acquisition module into the office peripheral. For example, an office peripheral may be capable of accepting a module in the form of a machine-level instruction sequence. Accordingly, when the office peripheral indicates that is capable of accepting a machine-level instruction sequence, one alternative embodiment of the present method provides for directing machine-level instructions to the office peripheral (step 115). An office peripheral may be capable of accepting a module in the form of an interpretive-level instruction sequence. This type of office peripheral typically includes an interpreter capable of executing the interpretive-level instruction sequence. When such an office peripheral indicates that it is capable of accepting a module in the form of an interpretive-level instruction sequence, another alternative embodiment of the present method provides for directing an interpretive-level instruction sequence to office peripheral (step 117). A different type of office peripheral may be capable of accepting a module in the form of a Java application. This type of office peripheral typically includes a Java engine that is capable of executing a Java application. A Java application, according to one alternative method, includes a Java applet that is typically executed by a browser. In either case, one alternative embodiment of the present method provides for directing a Java application to the office peripheral (step 119).

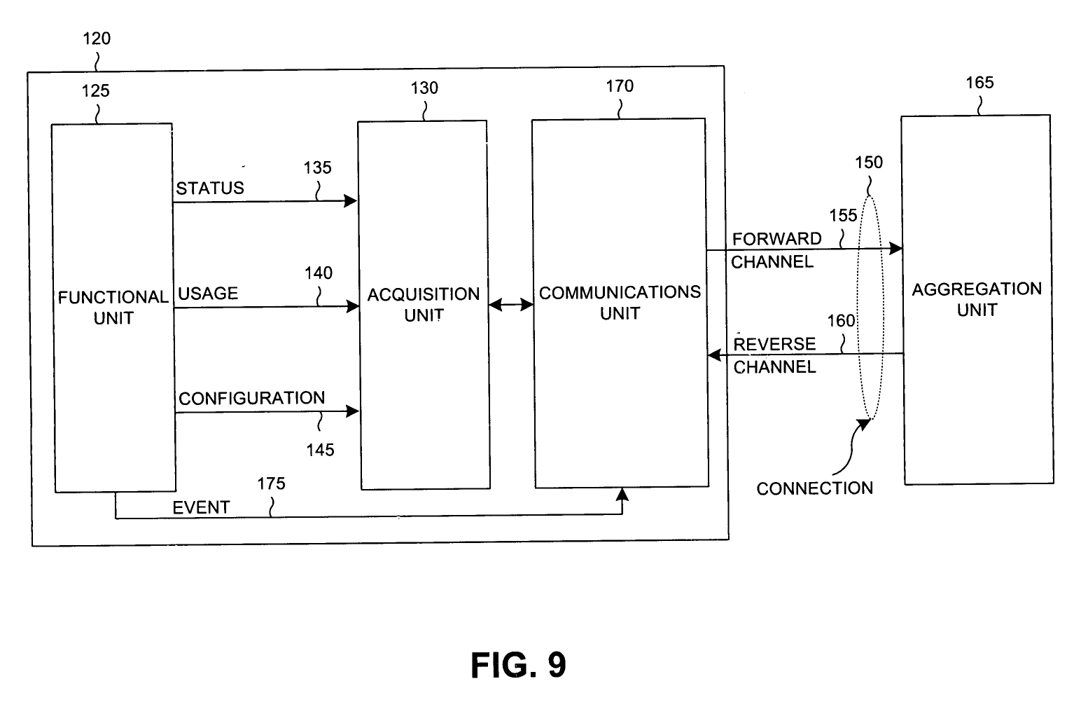

FIG. 9 is a block diagram that depicts one example embodiment of an office peripheral capable of communicating information according to the present method. According to this example embodiment, an office peripheral that is capable of communicating information to another device comprises a functional unit 125, an acquisition unit 130 and a communications unit 170. The functional unit 125 can include hardware and software components that collectively form specific functional aspects of the office peripheral. For example, in a printer, the functional unit 125 can include a laser print engine, a processor, a memory and an interface for receiving information. Memory in a printer may be used store various functional modules embodied as instruction sequences. These functional modules typically are executed by the processor and enable the processor to receive information from the interface and generate control signals enabling the laser print engine to print an image according to information received by way of the interface. It should be noted that this example of a functional unit 125 is presented here in order to illustrate one example embodiment of an office peripheral and is not intended to limit the scope of the claims appended hereto. Accordingly, other types of functional units commensurate with other types of office peripherals are to be included in the scope of the claims appended hereto. It should also be noted that the functional aspects of the acquisition unit 130 and the communications unit 170 can be included in the functional unit 125 itself. For example, the same interface that enables a printer to receive print information, according to one alternative embodiment, is used to establish a connection with an aggregation unit according to the teachings of the present method.

According to one alternative embodiment, the communications unit 170 establishes a communications channel with an aggregation unit 165. The acquisition unit 130 of one alternative embodiment collects information from within the office peripheral. This type of information includes, but is not necessarily limited to at least one of office peripheral status information 135, office peripheral usage information 140 and office peripheral configuration information 145. The office peripheral information collected by the acquisition unit 130 is conveyed to the aggregation unit 165 using a connection established by the communications unit 170. This is accomplished when the acquisition unit 130 conveys the information it collects from within the office peripheral to the communications unit 170. The communications unit 170 then conveys the office peripheral information to the aggregation unit 165 using an established connection. In order to guarantee delivery of the office peripheral information to the aggregation unit 165, one alternative embodiment of the communications unit 170 establishes a guaranteed delivery connection 150 to the aggregation unit 165. Guaranteed delivery is accomplished by establishing a guaranteed delivery connection 150 which itself includes a forward channel 155 and a reverse channel 160. The communications unit 170 of this alternative embodiment conveys the office peripheral information to the aggregation unit 165 using the forward channel 155. When the aggregation unit 165 successfully receives the office peripheral information, it directs an acknowledgment message to the communications unit 170 using the reverse channel 160. The communications unit 170 will continue to communicate office peripheral information to the aggregation unit 165 until it receives such an acknowledgment message. Various alternative embodiments of the communications unit 170 include an attempt counter that will prevent the communications unit 170 from falling into an endless loop that may result when the communications unit 170 attempts to communicate with an aggregation unit 165 that fails to provide an acknowledgment message in response to office peripheral information conveyed by the communications unit 170 to the aggregation unit 165 using the forward channel 155.

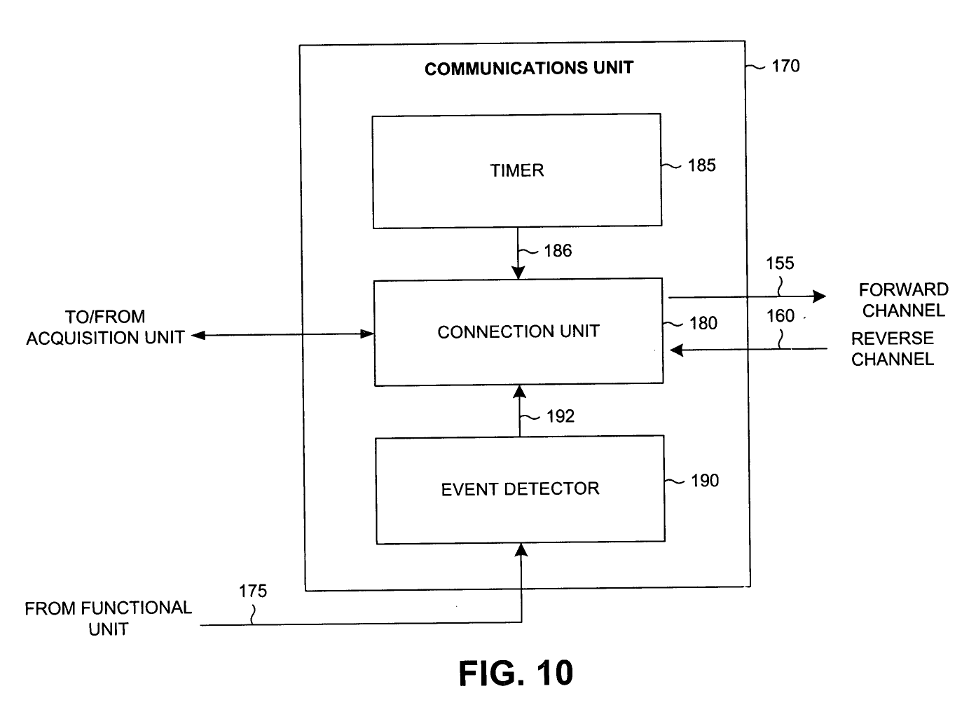

FIG. 10 is a block diagram that depicts alternative embodiments of a communications unit. According to one alternative embodiment, a communications unit 170 comprises a connection unit 180 that is capable of establishing a connection that includes a forward channel 155 and a reverse channel 160. The connection unit 180 conveys information from an office peripheral to an aggregation unit 165 using the forward channel 155. If the connection unit 180 does not receive an acknowledgement by way of the reverse channel 160, the connection unit 180 again conveys information from the office peripheral to the aggregation unit 165 using the forward channel 155. This continues until the device information from the office peripheral is acknowledged by the receiving aggregation unit 165 or the number of attempts to convey the information to the aggregation unit 165 is equal to (or greater than) a maximum attempt-count value. The attempt-count value is, for example, a pre-established value.

According to another alternative embodiment, the communications unit 170 further comprises a timer 185. The timer 185 of this alternative embodiment generates a connect signal 186 on a periodic basis. The connection unit 180 responds to the connect signal 186 by establishing a connection with an aggregation unit 165 as heretofore described. Once the connection unit 180 establishes a connection, the connection unit 180 retrieves office peripheral information from the acquisition unit 130. The connection unit 180 conveys the retrieved office peripheral information to the aggregation unit 165 using an established connection. According to yet another alternative embodiment, the communications unit 170 further comprises an event detector 190. The event detector 190 senses events that may occur within the functional unit 125. One example of an event is an “out-of-paper” indication that occurs in a printer. It should be noted that this example event is not intended to limit the scope of the claimed appended hereto. According to one illustrative alternative embodiment, the functional unit 125 generates an event signal 175. In response to the event signal 175, the event detector 190 generates a connect signal 192. The connect signal 192 is directed to the connection unit 180. The connection unit 180 responds to the connect signal 192 generated by the event detector 190 by establishing a connection to the aggregation unit 165. The connection unit 180 then retrieves office peripheral information from the acquisition unit 130 and conveys the office peripheral information to the aggregation unit 165 using the established connection.

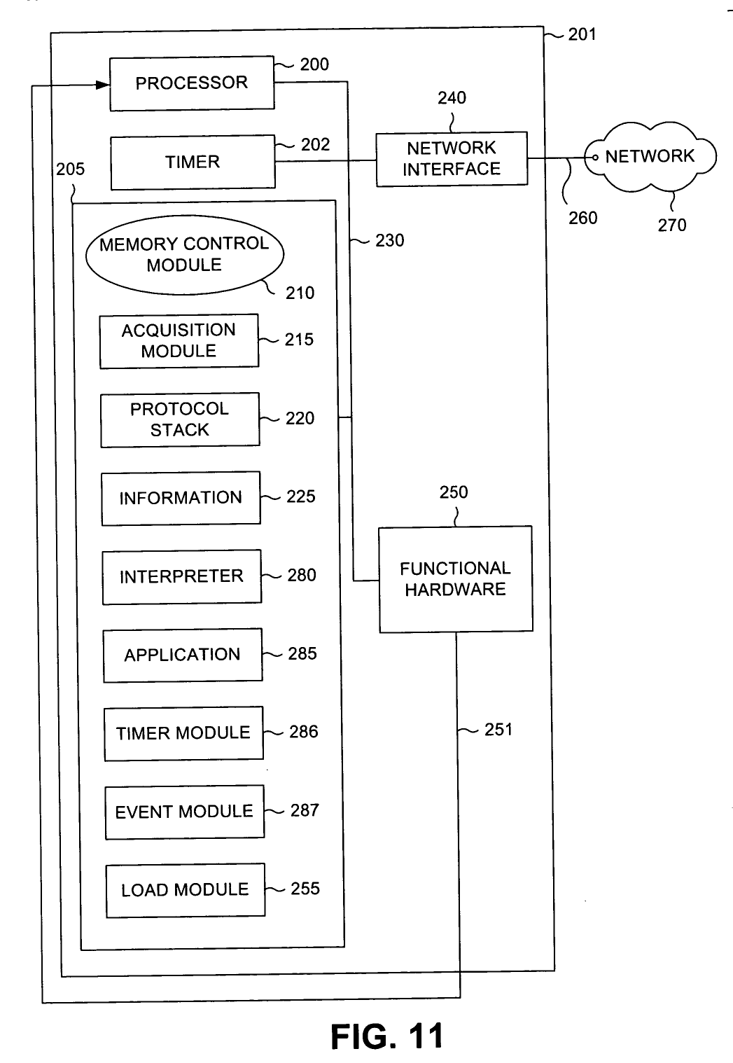

FIG. 11 is a block diagram that depicts one alternative embodiment of an office peripheral capable of communicating information to another device according to present method. According to this alternative embodiment, an office peripheral 201 comprises functional hardware 250, one or more processors 200, memory 205 and a network interface 240. Also included in this alternative embodiment of an office peripheral 201, are one or more functional modules. A functional module is typically embodied as an instruction sequence that is stored in the memory 205. According to one alternative embodiment, one or more of these functional modules is embodied as a machine-level instruction sequence. According to yet another alternative embodiment, one or more of these functional modules is embodied as an interpretive-level instruction sequence which will be described in greater detail infra.

An instruction sequence that implements a functional module, according to one alternative embodiment, is stored in the memory 205. The reader is advised that the term “minimally causes the processor” and variants thereof is intended to serve as an open-ended enumeration of functions performed by the processor 200 as it executes a particular functional module (i.e. instruction sequence). As such, an embodiment where a particular functional module causes the processor 200 to perform functions in addition to those defined in the appended claims is to be included in the scope of the claims appended hereto.

The functional modules (and their corresponding instruction sequences) described herein that enable the conveyance of office peripheral information according to the present method are, according to one alternative embodiment, imparted onto computer readable medium. Examples of such medium include, but are not limited to, random access memory, read-only memory (ROM), compact disk ROM (CD ROM), floppy disks, hard disk drives, magnetic tape and digital versatile disks (DVD). Such computer readable medium, which alone or in combination can constitute a stand-alone product, can be used to convert at least one of a general-purpose computing platform and a wide variety of other types of office peripherals as herein described into an office peripheral capable of conveying information to another device according to the techniques and teachings presented herein. Accordingly, the claims appended hereto are to include such computer readable medium imparted with such instruction sequences that enable execution of the present method and all of the teachings herein described.

Functional modules in one alternative embodiment include a control module 210, a protocol stack module 220 and an acquisition module 215. According to this alternative embodiment, the control module 210, when executed by the processor, minimally causes the processor to control the functional hardware 250 included in an office peripheral. It should be noted that the control module 210 may take on various forms according to the type of functional hardware 250 included in the office peripheral 201. As such, the scope of the claims appended hereto is to include all such variations of the control module 210 and all such variations of functional hardware 250. The protocol stack module 220, when executed by the processor, minimally causes the processor 200 to establish a connection with an aggregation unit. The protocol stack module 220, according to yet another alternative embodiment, minimally causes the processor 200 to establish a connection in accordance with a network protocol, e.g. TCP/IP. It should be noted that this example of a network protocol is not intended to limit the scope of the claims appended hereto and is presented herein for illustrative purposes only. According to yet another alternative embodiment, the protocol stack module 220, when executed by the processor 200, minimally causes the processor 200 to establish a guaranteed delivery connection.

FIG. 11 further illustrates that one example embodiment of an office peripheral 201 further comprises a timer module 286. The timer module 286, according to yet another alternative embodiment, uses a timer register 202 included in this alternative embodiment. The timer module 286, when executed by the processor 200, minimally causes the processor 200 to establish a connection period and to establish a connection according to the connection period commensurate with the teachings of the present method. The timer module 286 then causes the processor 200 to execute the acquisition module 215. As already discussed, execution of the acquisition module 215 minimally causes the processor 200 to acquire office peripheral information and to direct the acquired information to the protocol stack 220. According to yet another alternative embodiment, an office peripheral 201 further comprises an event module 287. The event module 287, according to one alternative embodiment, is executed by the processor 200 when the processor 200 receives an event signal 251 from the functional hardware 250. In response, the event module 287 is executed by the processor 200, thereby minimally causing the processor 200 to execute the acquisition module 215 in furtherance of acquisition of information from within the office peripheral and conveyance of said information to the protocol stack 220. In either of these cases, the protocol stack 220 establishes a connection to an aggregation unit. According to one alternative embodiment, the processor 200, as it executes the protocol stack module 220, is minimally caused to control the network interface 240 as a means for conveying 260 information to a network 270. According to yet another alternative embodiment, the protocol stack module 220 further minimally causes the processor 200 to establish a guaranteed delivery connection to an aggregation unit by way of the network interface 220 (and the network 270).

According to yet another example embodiment, the office peripheral 201 further comprises a load module 255. The load module 255, when executed by the processor 200, minimally causes the processor 200 to receive an acquisition module and store the acquisition module in the memory 205. It should be noted that one example embodiment of an office peripheral 201 does not include the acquisition module 215 as an originally provided functional module. In this alternative embodiment, the load module 255 accepts an acquisition module as a seeded module from another device attached to the network 270.

In yet another alternative embodiment, the load module 255 accepts an interpretive-level instruction sequence, also known as an “application” 285. This example alternative embodiment further comprises an interpreter 280. The interpreter 280, when executed by the processor 200, minimally causes the processor 200 to execute the application. In this alternative embodiment the processor 200, as it executes the load module 255, is minimally caused to accept an application 285 and store the application 285 in the memory 205. According to yet another alternative embodiment, the application 285 comprises a Java application and the interpreter 280 comprises a Java engine.

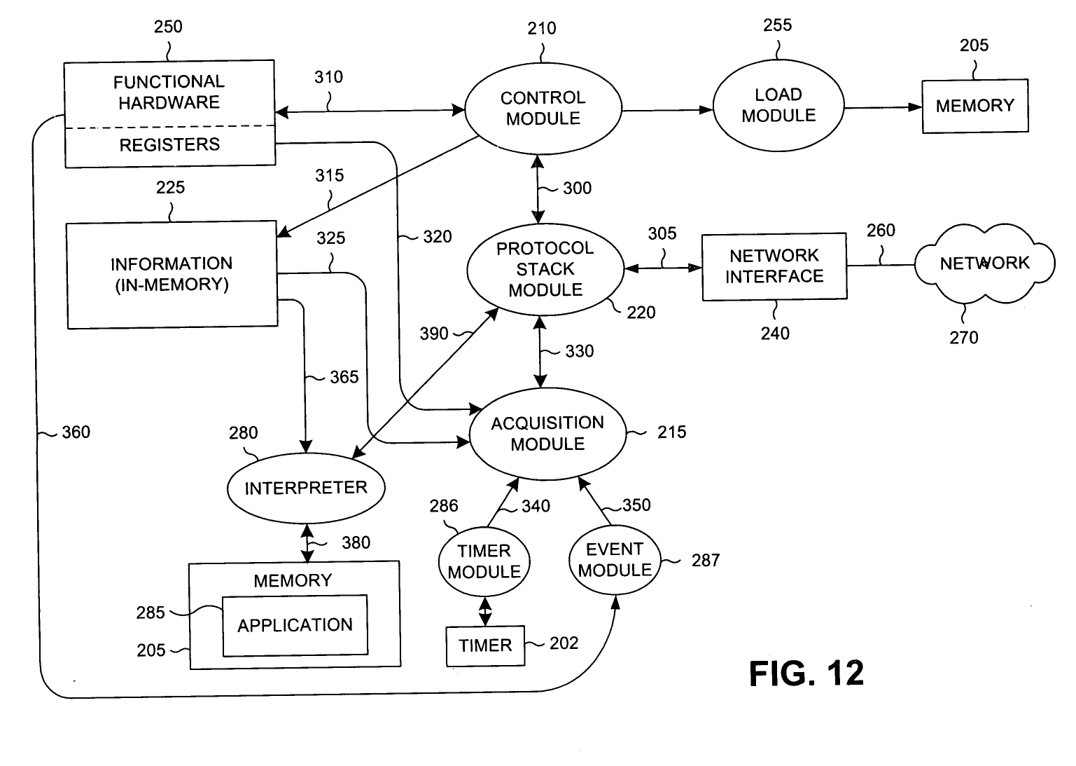

FIG. 12 is a data flow diagram that depicts the operation of one alternative embodiment of an office peripheral capable of communicating information to another device according to the present method. As already discussed, the control module 210, when executed by the processor 200, minimally causes the processor 200 to enable the functionality of the functional hardware 250. Accordingly, the processor 200 interacts 310 with the functional hardware 250. In operation, the control module 210 interacts 300 with a protocol stack module 220 included in one illustrative embodiment. The protocol stack module 220, when executed by the processor 200, causes the processor 200 to receive 305 information from the network interface 240. According to one illustrative embodiment, the protocol stack module 220 embodies a transport control protocol/Internet protocol (TCP/IP) protocol stack. This example of a protocol stack is presented here to illustrate one example embodiment and is not intended to limit the scope of the claims appended hereto. Office peripheral information is developed as the control module 210 is executed by the processor 200. The control module 210, when executed by the processor 200, minimally causes the processor 200 to store 315 office peripheral information in an information region 225 included in the memory 205. Some other forms of office peripheral information, according to one alternative embodiment, are available in registers included in the functional hardware 250.

In operation, the acquisition module 215, when executed by the processor 200, causes the processor 200 to acquire office peripheral information from at least one of the registers (path 320) included in the functional hardware 250 and from the information region 225 (path 325) included in the memory 205. Commensurate with the teachings of the present method, the office peripheral information acquired by the processor 200 as it executes the acquisition module 215 includes at least one of office peripheral status information, office peripheral usage information and office peripheral configuration information.

According to one alternative embodiment, the timer module 286 causes 340 the processor 200 to execute the acquisition module 215. The timer module 286 causes the processor 200 to set the timer 202. When the timer 202 expires, the timer module 286 causes the processor to execute the acquisition module 215. In this situation, the processor 200, as it executes the acquisition module 215, acquires office peripheral information and conveys 330 the office peripheral information to the protocol stock module 220. The protocol stack module 220 is executed by the processor 200 thereby minimally causing the processor 200 to interact with the network interface 240 so as to convey 260 office peripheral information to the network 270. According to yet another alternative embodiment, the event module 287 is executed by the processor 200 in response to an event signal 360 receive from the functional hardware 250. The event module 287 then causes 350 the processor 200 to execute the acquisition module 215 thereby affecting collection of office peripheral information and conveyance of the office peripheral information to the network 270 by further execution of the protocol stack module 220.

FIG. 12 further illustrates that, according to one alternative embodiment, the processor 200 executes the load module 255. The load module 255, when executed by the processor 200, minimally causes the processor 200 to receive an application and to store said application into the memory 205. As such, the processor 210 then executes the application seeded into the memory 205. As also illustrated in FIG. 12, an application 285 can be executed 380 as the processor 200 executes an interpreter module 280. In this situation, the interpreter 280 minimally causes the processor 200 to retrieve 380 instructions from the application 285. The interpreter 280 further minimally causes the processor 200 to execute the instructions received from the application 285.

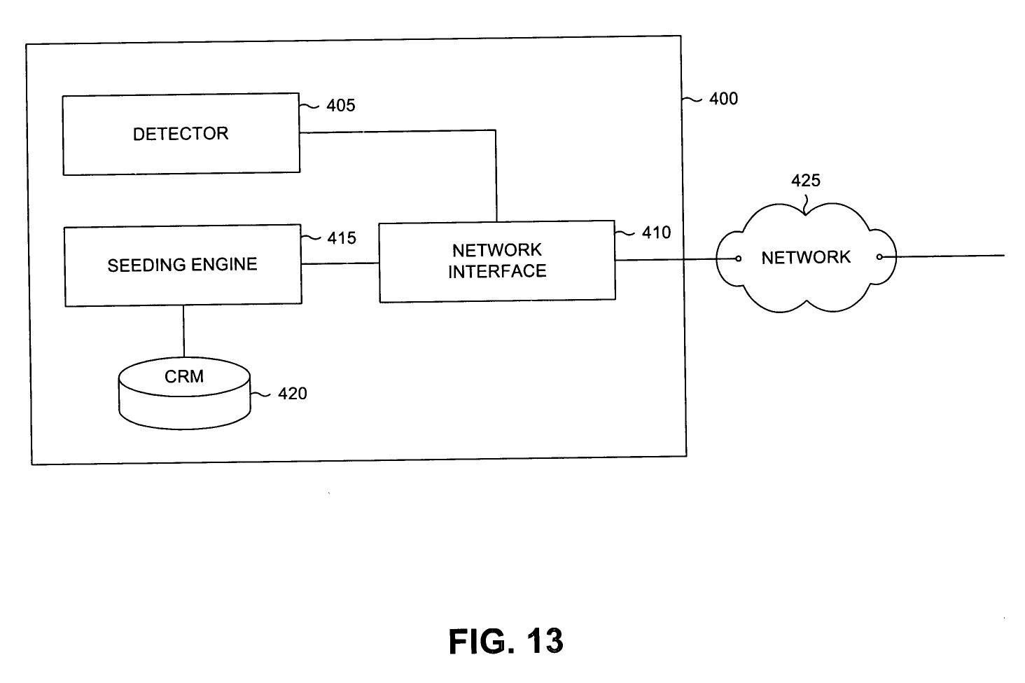

FIG. 13 is a block diagram that depicts one example embodiment of an office peripheral seeding apparatus. According to this example embodiment, an office peripheral seeding apparatus 400 comprises a detector 405, a computer readable medium 420, a seeding engine 415 and a network interface 410. The network interface 410 enables communication with a network 425. The network interface 410 also allows the detector 405 to discover an office peripheral attached to the network 425. Imparted onto the computer readable medium 420 are one or more instructions sequence modules that collectively comprise an acquisition suite. According to this example embodiment, the acquisition suite includes an acquisition module that, when executed by a processor, minimally causes the processor to establish a connection to an aggregation unit by executing a protocol stack module. The acquisition module of this example embodiment also causes the processor to collect office peripheral information and to convey the office peripheral information to the aggregation unit. The detector 405 generates a signal when it detects an office peripheral attached to the network and when said office peripheral requires seeding of an acquisition suite. For example, a detected office peripheral may not include an acquisition suite that is substantially equivalent to the acquisition suite imparted onto the computer readable medium 420. In response to the signal generated by the detector 405, the seeding engine 415 retrieves the acquisition suite stored on the computer readable medium 420 and directs the acquisition suite to the network interface 410. The network interface 410 conveys the acquisition suite to the office peripheral detected by the detector 405. According to one alternative embodiment, one or more of the instruction sequences included in the acquisition suite comprise a machine-level instruction sequences. According to yet another alternative embodiment, one or more of the instruction sequences included in the acquisition suite comprise an interpretive-level instruction sequence. According to yet another alternative embodiment, one or more of the instruction sequences included in the acquisition suite comprise a Java application. It should be noted that a Java application can, according to one alternative embodiment, comprise a Java applet to that can be executed by a Web browser.

While this method and apparatus have been described in terms of several alternative exemplary embodiments, it is contemplated that alternatives, modifications, permutations, and equivalents thereof will become apparent to those skilled in the art upon a reading of the specification and study of the drawings. It is therefore intended that the true spirit and scope of the appended claims include all such alternatives, modifications, permutations, and equivalents.

What is claimed is:

1. A method for conveying information from an office peripheral comprising:
establishing a connection to an aggregation module from an acquisition module included in the office peripheral; and
communicating information from the office peripheral to the aggregation module using the established connection.

2. The method of claim 1 wherein establishing a connection comprises:
establishing a connection period; and
establishing a connection from an acquisition module included in the office peripheral to an aggregation module according to the connection period.

3. The method of claim 1 wherein establishing a connection comprises establishing a connection from an acquisition module included in the office peripheral to an aggregation module when an event is detected.

4. The method of claim 1 wherein establishing a connection comprises establishing a guaranteed delivery connection from an acquisition module included in the office peripheral to an aggregation module.

5. The method of claim 1 wherein communicating information comprises communicating at least one of office peripheral status information, office peripheral usage information and office peripheral configuration information.

6. The method of claim 1 further comprising:
discovering the office peripheral; and
seeding an acquisition suite in to the office peripheral when the office peripheral does not include an acquisition suite and when the office peripheral is capable of accepting and executing an acquisition suite.

7. The method of claim 6 wherein seeding an acquisition suite in to the office peripheral comprises directing a machine-level instruction sequence to the office peripheral when the office peripheral indicates that it can accept a machine-level instruction sequence.

8. The method of claim 6 wherein seeding an acquisition suite in to the office peripheral comprises directing an interpretive-level application to the office peripheral when the office peripheral indicates that it can accept an interpretive-level application.

9. The method of claim 6 wherein seeding an acquisition suite in to the office peripheral comprises directing a JAVA application to the office peripheral when the office peripheral indicates that it can accept a JAVA application.

10. An office peripheral comprising:
functional unit;
communication unit capable of establishing a connection with an aggregation unit; and
acquisition unit capable of acquiring information from the functional unit and conveying said information by way of a connection established by the communication unit.

11. The office peripheral of claim 10 wherein the communication unit comprises:
timer that generates a connect signal; and
connection unit that is capable of establishing a connection with an aggregation unit according to the connect signal.

12. The office peripheral of claim 10 wherein the communication unit comprises:
event detector that generates a connect signal when an event is detected; and
connection unit that is capable of establishing a connection with an aggregation unit according to the connect signal.

13. The office peripheral of claim 10 wherein the communication unit is capable of establishing a guaranteed delivery connection to an aggregation unit.

14. The office peripheral of claim 10 wherein the acquisition unit is capable of acquiring at least one of office peripheral status information, office peripheral usage information and office peripheral configuration information.

15. An office peripheral comprising:
office peripheral functional hardware;
network interface capable of communication with a communications network;
processor capable of executing an instruction sequence;
memory for storing an instruction sequence; and
instruction sequence modules stored in the memory including:
device control module instruction sequence that, when executed by the processor, minimally causes the processor to control the office peripheral functional hardware;
protocol stack module that, when executed by the processor, minimally causes the processor to establish a connection with an aggregation unit using the network interface; and
acquisition module that, when executed by the processor, minimally causes the processor to collect device information and to convey the device information to the aggregation unit using a connection established by the processor when it executes the protocol module stack.

16. The office peripheral of claim 15 further comprising a timer and a timer module instruction sequence and wherein the timer module instruction sequence further minimally causes the processor to:
set the timer;
cause the processor to collect device information according to the timer by executing the acquisition module; and
cause the processor to execute the protocol stack to establish a connection with an aggregation module according to the timer.

17. The office peripheral of claim 15 further comprising an event module that, when executed by the processor, minimally causes the processor to respond to an event by:
executing the acquisition module so as to collect device information; and
executing the protocol stack to establish a connection so as to convey device information from the acquisition module to an aggregation module.

18. The office peripheral of claim 15 wherein the protocol stack module minimally causes the processor to establish a connection by minimally causing the processor to establish a guaranteed delivery connection with an aggregation module.

19. The office peripheral of claim 15 wherein the acquisition module minimally causes the processor to collect device information by minimally causing the processor to collect at least one of device status information, device usage information and device configuration information.

20. A computer readable medium having imparted thereon one or more instruction sequence modules for collecting device information from an office peripheral including an acquisition module that, when executed by a processor, minimally causes the processor to:
establish a connection to an aggregation unit by executing a protocol stack module;
collect office peripheral device information; and
convey the office peripheral device information to the aggregation unit using a connection established by the processor when it executes the protocol module stack.

21. The computer readable medium of claim 20 further comprising a timer management module that, when executed by a processor, minimally causes the processor to:
establish a connection period; and
establish a connection with an aggregation unit by executing a protocol stack module according to the connection period.

22. The computer readable medium of claim 20 further comprising an event management module that, when executed by a processor, minimally causes the processor to establish a connection with an aggregation unit by executing a protocol stack module when it detects an event.

23. The computer readable medium of claim 20 wherein the acquisition module causes a processor to establish a connection by minimally causing a processor to establish a guaranteed connection with an aggregation unit by executing a protocol stack module.

24. The computer readable medium of claim 20 wherein the acquisition module causes a processor to collect device information by minimally causing a processor to collect at least one of device status information, device usage information and device configuration information.

25. The computer readable medium of claim 20 wherein one or more of the instruction sequence modules comprises a machine-level instruction sequence.

26. The computer readable medium of claim 20 wherein one or more of the instruction sequence modules comprises an interpretive-level application.

27. The computer readable medium of claim 20 wherein one or more of the instruction sequence modules comprises a JAVA application.

28. An office peripheral seeding apparatus comprising:
detector capable of detecting an office peripheral;
computer readable medium having imparted thereon an acquisition suite including one or more instruction sequence modules for collecting office peripheral information including an acquisition module that, when executed by a processor, minimally causes the processor to:
establish a connection to an aggregation unit by executing a protocol stack module;
collect office peripheral information; and
convey the office peripheral information to the aggregation unit using a connection established by the processor when it executes the protocol module stack;
network interface capable of conveying the acquisition suite to a detected office peripheral and allowing the detector to detect an office peripheral; and
seeding engine capable retrieving the acquisition suite from the computer readable medium and directing the acquisition suite to the network interface when the detected office peripheral does not include an equivalent acquisition suite.

29. The office peripheral seeding apparatus of claim 28 wherein the acquisition suite includes one or more instruction sequences comprising a machine-level instruction sequence.

30. The office peripheral seeding apparatus of claim 28 wherein the acquisition suite includes one or more instruction sequences comprising an interpretive-level instruction sequence.

31. The office peripheral seeding apparatus of claim 28 wherein the acquisition suite includes one or more instruction sequences comprising a JAVA application.

32. An office peripheral comprising:
means for performing an office peripheral function;
means for establishing a connection to an aggregation module;
means for acquiring information from the means for performing an office peripheral function; and
means for directing the acquired information to a connection established by the means for establishing a connection to an aggregation module.

33. The device of claim 32 wherein the means for establishing a connection comprises:
means for establishing a connection period; and
means for establishing a connection to an aggregation module according to the connection period.

34. The device of claim 32 wherein the means for establishing a connection comprises a means for establishing a connection to an aggregation module when an event is detected.

35. The device of claim 32 wherein the means for establishing a connection comprises establishing a guaranteed delivery connection to an aggregation module.

36. The device of claim 32 wherein the means for acquiring information comprises a means for acquiring at least one of office peripheral status information, office peripheral usage information and office peripheral configuration information.
